(19) United States
(12) Patent Application Publication
(10) Pub. No.: US 2003/0007703 A1
(43) Pub. Date: Jan. 9, 2003

(54) Configurable image processing logic for use in image processing devices

(76) Inventor: Eugene A. Roylance, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/898,785

(22) Filed: Jul. 3, 2001

(51) Int. Cl. G06K 9/54; G06K 9/60

(52) U.S. Cl. 382/303

(57) ABSTRACT

Configurable image processing logic is provided for use in image processing devices. The configurable image processing logic includes memory and a plurality of image processing logic modules implementing different image processing algorithms. The logic modules are selectively configured and operated via communication logic that allows for a variety of different paths through the image processing logic modules to form an applicable image processing pipeline for a given image processing data/task.

### TECHNICAL FIELD

The present invention relates generally to image processing devices, and more particularly to configurable image processing logic for use in image processing devices.

### BACKGROUND

Image processing devices, such as, for example, color printers, monochrome printers, scanners, facsimiles, copiers, cameras (still and video), computers, and other similar devices, usually include logic configured to perform algorithms on the image processing data. Special processing modules are often provided to break compute intensive functions into more manageable pieces. These processing modules, which may be implemented in hardware, firmware, and/or software, are combined in a particular order to form an image processing pipeline. Image processing pipelines are usually operated in a sequential manner and in some particular order, depending upon the type/format of the image data to be processed. Image processing pipelines are usually optimized for certain types of data, as would be expected for a given image processing device.

If an image processing device is meant to handle different formats or types of data, then a plurality of image processing pipelines may be required. Alternatively, a selectively configurable image processing pipeline may be implemented to provide different paths for the data processing. In either case, the resulting image processing pipeline is essentially an ordered grouping of algorithms, which are executed in some form of logic using certain parameters as required to handle a particular type of image data.

Once an image processing pipeline has been appropriately configured, image data can then be streamed, or otherwise provided, through the pipeline and processed accordingly. Examples of logic modules include a half-toning module, a filtering module, a convolution module, an integrating module, a template matching module, a thresholding process module, a matrix operating module, a decoding/decompressing module, a coding/compressing module, etc. Thus, these and other exemplary image processing related logic modules can be combined, as required, to perform the necessary image processing in an image processing device.

In many image processing devices there is often a need for expedient processing of image data. Consequently, most image processing pipelines are configured using hardware logic modules. In order to selectively arrange or rearrange these logic modules into different paths within an image processing pipeline, additional hardware is typically provided to selectively switch/multiplex signals/data, and the handling thereof, between the various logic modules. Designing and providing such configurable pipelines tends to be costly and usually image processing device dependent. Thus, for example an image processing pipeline designed for use in a color laser printer may not be readily adaptable for use in a scanner or copier. Moreover, additional work/resources may required to modify or alter the operation of the image processing pipeline during future builds.

Thus, there is a need for improved apparatuses for use in image processing devices, and in particular for improved image processing logic that is readily adaptable and/or modifiable for use in different image processing devices, or later improved versions of existing image processing devices. Preferably, the improved apparatuses, can be developed, tested, and implemented using conventional hardware, firmware, and/or software techniques.

### SUMMARY

In accordance with certain aspects of the present invention, improved apparatuses are provided for use in image processing devices. For example, improved image processing logic is provided that is readily adaptable and/or modifiable for use in different image processing devices. The image processing logic can also be reconfigured as needed for use in subsequent versions of an image processing device. Furthermore, the improved image processing logic provided herein can be developed, tested, and implemented using conventional hardware, firmware, and/or software techniques.

Thus, for example, in accordance with certain aspects of the present invention, an apparatus is provided, which includes a plurality of logic modules, wherein each of the logic modules is configured to selectively process image related data according to a different image processing algorithm. These logic modules are selectively coupled together by communication logic that is configured to selectively route the image related data to and/or from the various logic modules in accordance with a data processing order. In certain implementations, the data processing order establishes an image processing pipeline that includes the image processing algorithms of at least two of the logic modules.

### BRIEF DESCRIPTION OF THE DRAWINGS

A more complete understanding of the present invention may be had by reference to the following detailed description when taken in conjunction with the accompanying drawings wherein:

FIG. 1 is a block diagram depicting a computing environment having a plurality of computing resources and image processing devices, in accordance with certain exemplary implementations of the present invention.

FIG. 2 is a block diagram depicting selected portions of an image processing device, for example, as in FIG. 1, in accordance with certain exemplary implementations of the present invention.

FIG. 3 is a block diagram depicting configurable image processing logic suitable for use in an image processing device, such as, for example, as in FIG. 2, in accordance with certain exemplary implementations of the present invention.

FIG. 4 is an illustrative diagram depicting a message format suitable for use in configurable image processing logic, such as, for example, as in FIG. 3, in accordance with certain exemplary implementations of the present invention.

FIG. 5 is a flow diagram depicting a method suitable for use in configurable image processing logic, for example, as in FIG. 3, in accordance with certain exemplary implementations of the present invention.

### DETAILED DESCRIPTION

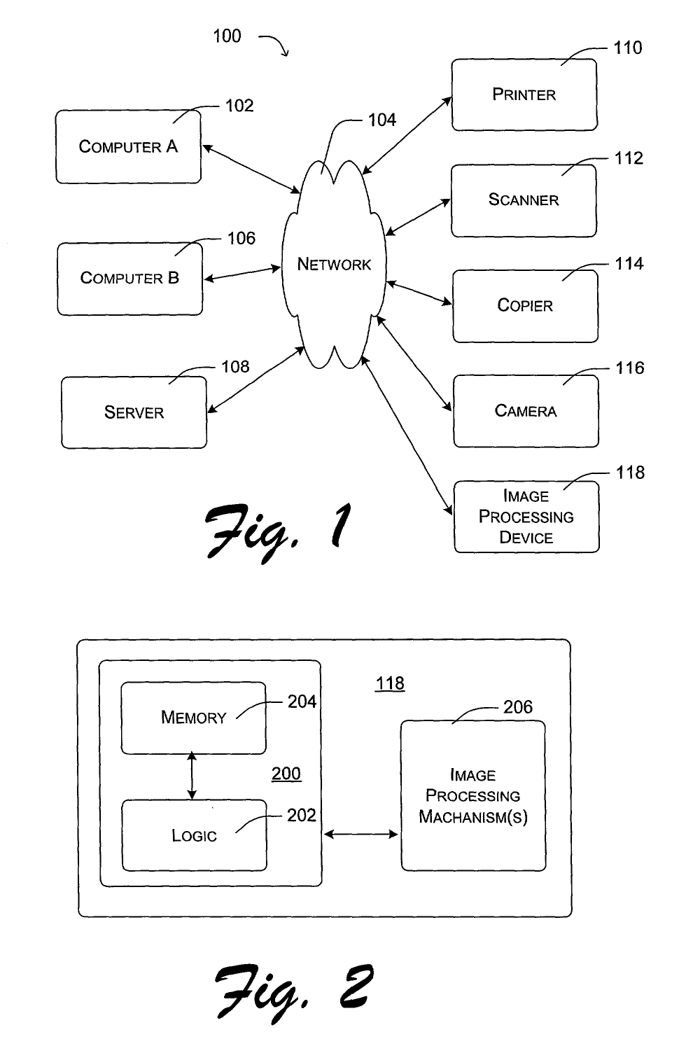

FIG. 1 depicts an environment 100, in accordance with certain exemplary implications of the present invention. Computing environment 100 includes a first computer 102 that is connected (operatively coupled) to at least one network/interface 104. Networks/interface 104 provides operational connectivity between first computer 102 and one or more other devices. Here, for example, a second computer 106 is shown connected to network/interface 104. A server 108 is also shown as being connected to network/interface 104. First computer 102, second computer 106 and server 108 may communicate with one another and share data with one another through network/interface 104, as is commonly known.

Computing environment 100 also includes several exemplary image processing devices, each being connected to network/interface 104. Here, a printer 110, a scanner 112, a copier 114, a camera 116, and a representative image-programming device 118 are shown. Printer 110 may be a monochrome printer or color printer, a laser printer, an ink jet printer, or the like. Scanner 112 may be, for example, a flat bed scanner or other like stand-alone scanner, or a scanning capability integrated within another image processing device. For example scanner 112 and copier 114 may be combined. This combination may also be combined with printer 110. These and other configurations for image processing devices are well known.

Camera 116 may be, for example, a digital still camera, a video camera, or the like, which is configured to capture or otherwise generate images in some format. Image processing device 118 is provided as a representative for these and/or any other types of image processing devices that may be used to process image related data.

With respect to computing environment 100, image data may be provided or otherwise shared amongst any of the interconnected devices. Thus, for example, first computer 102 may provide image data to printer 110 for further processing and generation of a print out version of the image data. Scanner 112, which may also include facsimile capabilities, can be used to import image data through network/interface 104 to server 108. Image data stored on server 108 may than be accessed, for example, by computer 106. However used, each of the image processing devices depicted on FIG. 1 requires the capability to process image related data, either incoming and/or outgoing.

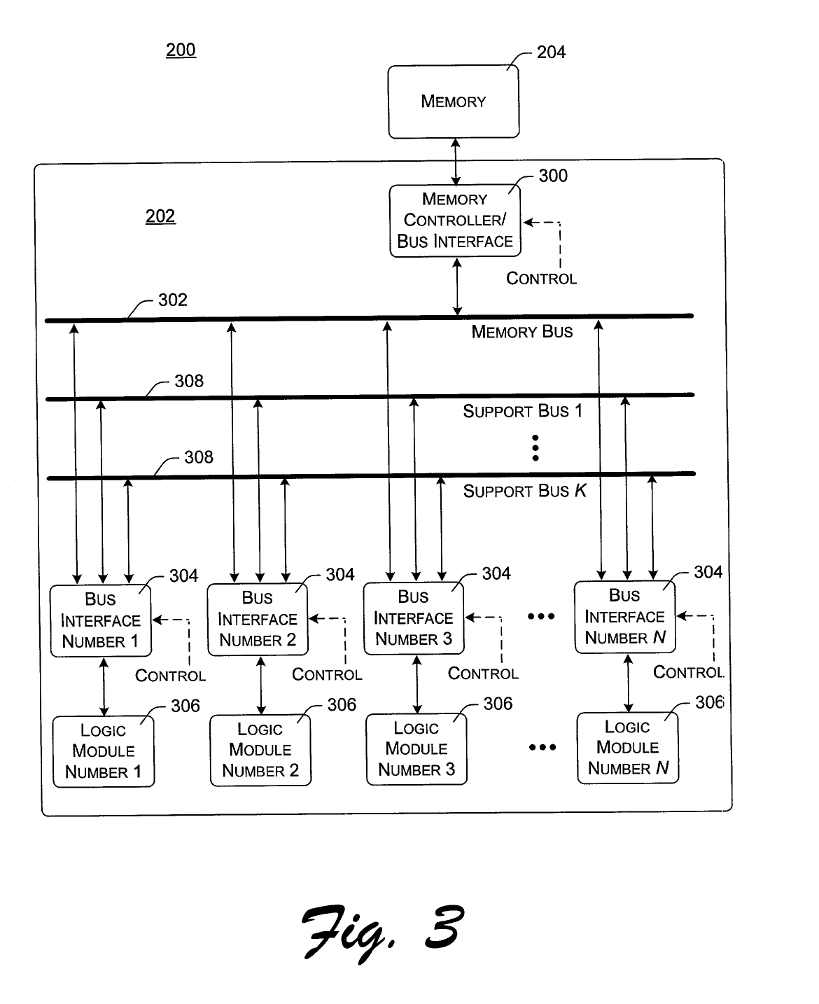

With this in mind, FIG. 2 depicts an exemplary image processing device 118, in accordance with certain implementations of the present invention. Image processing device 118 includes a configurable image processing pipeline 200. In this example, configurable image processing pipeline 200 includes logic 202 and memory 204. Logic 202 may be implemented using hardware, firmware, and/or software techniques. By way of example, in accordance with certain exemplary implementations of the present invention, logic 202 may include one or more applications specific integrated circuits (ASICs).

Memory 204 may include any conventional form of random access memory (RAM), for example. As depicted, logic 202 is configured to input/output data and/or control information, selectively access memory 204, and further provide/receive data to/from one or more image processing mechanisms 206. Image processing mechanisms 206 include a variety of hardware, software, and mechanical mechanisms as required by image processing device 118 to complete its processing function.

For example, image processing mechanisms 206 in printer 110 may include applicable electrical and mechanical arrangements as needed to convert image processed data from configurable image processing pipeline 200 into a print out of some type. If image processing device 118 were a scanner, such as scanner 112, then image processing mechanisms 206 may include the electrical and mechanical arrangements necessary to capture image data and provide the captured image data to configurable image processing pipeline 200. A copier 114, would operate with similar image processing mechanisms 206. A camera 116, would require image processing mechanisms 206 suitable for capturing optically gathered image data. These are but a few examples for image processing mechanisms 206. Those skilled in the art will recognize other electrical and mechanical mechanisms may be included in the representative, image processing mechanisms block 206.

Reference is now made to FIG. 3, which is a block diagram depicting an exemplary configurable image processing pipeline containing logic 202 and memory 204. Here, logic 202 is connected to memory 204 through a memory controller/bus interface 300. Memory controller/bus interface 300 is connected to a memory bus 302. Also connected to memory bus 302 are a plurality of bus interfaces 304. Here, for example, bus interfaces 1, 2, 3, . . . , N, are depicted as being connected to memory bus 302. Each of the bus interfaces 304 is further connected to a logic module 306. Each of the bus interfaces 304 is further connected to one or more support buses 308, in this example, support buses 1−K. As used herein, variables N and K may represent any integer greater than 1.

Logic modules 306 represent implementations of one or more image processing algorithms, and/or portions thereof. Logic modules 306 may be selectively combined to form a variety of different image processing pipelines, for example, as required by an image processing device 118 (FIG. 1). Logic modules 306 are selectively combined to form image processing pipelines by way of memory bus 302 and one or more of the support buses 308.

By way of example, a module number 1, which is connected to bus interface number 1, may be selectively configured to access image data from memory 204 through memory bus 302 and memory controller/bus interface 300. Upon completing all or part of the processing of the image data, logic module number 1 can provide the corresponding first processed image data back to memory 204, once again, via memory bus 302 and memory controller/bus interface 300. Next, according to an exemplary pipeline-processing scheme, this first processed image data, which in this example is stored in memory 204, is to be further processed by logic module number 2. Thus, once the first processed image data or a portion thereof is stored in memory 204, logic module number 2 may access this data though bus interface number 2 and via memory bus 302 and memory controller/bus interface 300.

In other exemplary implementations, logic module number 2 may receive the first processed image data or some portion thereof directly from logic module number 1 through bus interface number 1 and bus interface number 2, via support bus number 1.

In this manner, data may be shuffled back and forth over the different buses between various logic modules 306 (and/or memory 204), as needed, to support the configured image processing pipeline. In such configurations, support buses 308 provide either dedicated or shared data paths over which image data (and any associated control data) can be shared between the various logic modules 306.

To support this configurable architecture, the use and access to memory bus 302 and the any support bus 308 needs to be controlled. Such control functionality can be distributed, as in this example, between the various bus interfaces 304 and also memory controller/bus interface 300. Thus memory bus 302 is a negotiated bus that is shared between the various logic modules 306 and the memory controller portion of memory controller/bus interface 300. Support buses 308 may be programmably configured for use with specific logic modules 306, or otherwise configured as shared resource (e.g., negotiated) in support of the different logic modules 306. Bus controlling and interfacing techniques, such as these and others, are well known.

Although FIG. 3 only depicts a single memory bus 302, it should be understood, that a plurality of memory buses may be provided and operatively coupled to one or more bus interfaces 304.

By using the exemplary configuration shown in FIG. 3, image processing pipeline 200 can be configured to support a variety of image processing needs. By way of example, logic modules 306 may include half-toning modules, filtering modules, convolution modules, integrating modules, template matching modules, thresholding process modules, matrix operating modules, decoder modules, decompressor modules, coder modules, compression modules, decompression modules, and other similar image processing logic/algorithms.

As can be appreciated, configurable image processing pipeline 200 may be configured for use in a variety of different types of image processing devices. During the design phase, logic modules 306 may be easily swapped out, disabled, enabled, and/or otherwise modified as needed to meet the image processing requirements of a given image processing device and/or image data, without having to significantly alter the supporting interconnecting elements.

As depicted in FIG. 3, control signals may also be provided to each of the bus interfaces 304 and memory controller/bus interface 300, as needed to support certain dedicated or shared configurations of the connected buses. Such control signals may come from a general purpose or a special purpose controller module/logic module, for example.

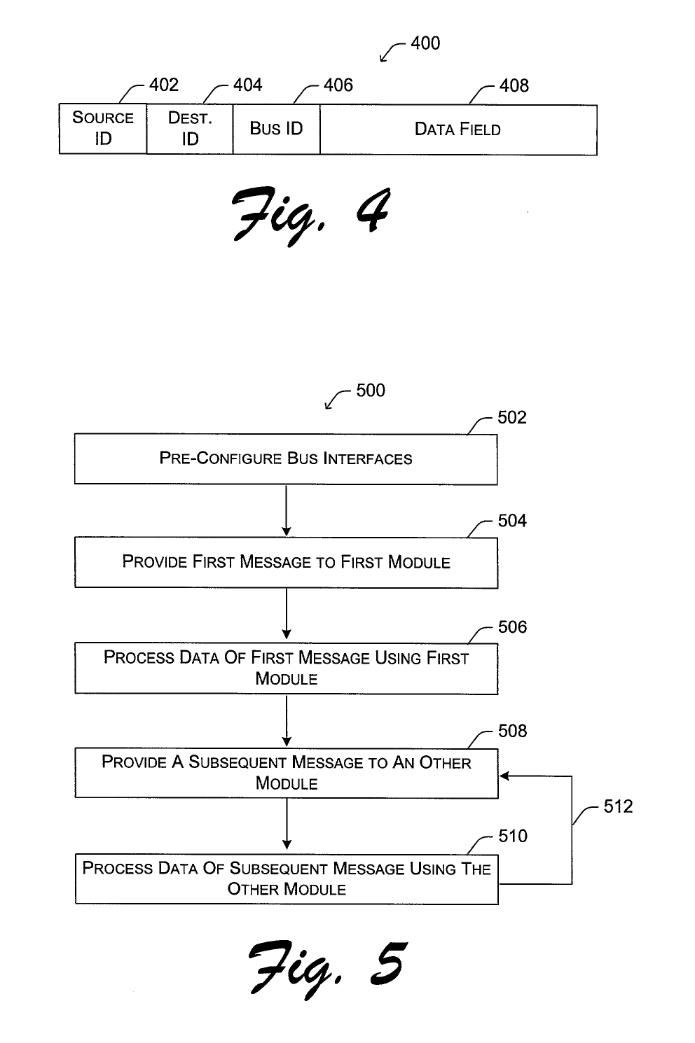

A message passing scheme or protocol, can be use to pass control and/or data information between the various bus interfaces 304 and memory controller/bus interface 300. The context of an exemplary message 400 is depicted in FIG. 4. Here, message 400 includes an optional source interface identifier 402, a destination interface identifier 404, a bus identifier 406, and a data field 408, which may include image data, data indexes, address information, e.g., associated with image data, and other data, such as, control data. For example, address information in data field 408 may define the location of image data in memory 204. Using message 400, each of the bus interfaces 304 and memory controller bus interface 300 may monitor bus traffic for messages directed to their respective logic module/memory, for example, based on information provided in destination interface identifier 404.

Those skilled in the art will recognize that other message formats may also be used to coordinate and support the processing of image data by the various logic modules 306 and memory 204. By way of example, in certain implementations, message 400 could include the address of a memory bus to allow the various bus interfaces to be memory mapped.

FIG. 5 is a flow diagram depicting a method 500 for use in the configurable image processing pipeline 200. In step 502, the bus interfaces may, be pre-configured to provide a certain pipeline configuration. Step 502 is optional, and may be performed during a design/fabrication stage, and/or, in some implementations, subsequent to the design/fabrication stage (e.g., if the pipeline configuration is reprogrammable).

In step 504, a first message is provided to a first logic module 306. Next in step 506, the first logic module 306 processes the data associated with the first message. Either upon completion or during processing of the first message image data, as depicted in step 508, a subsequent message can be provided to another logic module 306. This subsequent message identifies image data to be processed by the other logic module. In step 510, the data associated with the subsequent message is processed by the other logic module 306. As depicted by arrow 512, steps 508 and 510 may be repeated as necessary for a plurality of logic modules 306 that form the image processing pipeline.

In accordance with certain aspects of the present invention, the apparatuses described above can be configured to allow a plurality of logic modules 306 to communicate peer-to-peer and/or to memory 204 simultaneously. Such a configuration allows for multiple logic module image processing pipelines to be selectively formed.

For example, a three module image processing pipeline may include a first logic module 306 that is configured to decompress data. This data decompression module could be arranged to access image data in memory 204, via memory bus 302, and decompress into corresponding raw image data. This raw image data output from the data decompression module would then be provided to a second logic module 306 via a support bus. Here, for example, the second logic module 306 could be a halftone module configured to receive the raw image data and generate corresponding monochrome raster image data. Next, the raster image data from the halftone module could be provided to a third logic module 306, via another support bus. The third logic module 306 could be a marking device module that is configured to output print driving engine control input/output (I/O) signals or the like, based on the raster image data, which allow the image data to be printed.

Although some preferred implementations of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

1. An apparatus comprising:
a plurality of logic modules, each logic module being configured to selectively process image related data according to a different image processing algorithm; and
communication logic operatively coupled to each of the logic modules and configured to selectively route the image related data to the plurality of logic modules for processing in accordance with a data processing order.

2. The apparatus as recited in claim 1, wherein the communication logic includes:
a plurality of bus interfaces, each bus interface being operatively coupled to a corresponding logic module; and
a plurality of buses, operatively coupled to route the image related data between the plurality of bus interfaces.

3. The apparatus as recited in claim 2, wherein the plurality of buses includes at least one memory bus and at least one support bus, and further comprising a memory bus interface operatively coupled to the memory bus.

4. The apparatus as recited in claim 3, wherein the memory bus interface is further configured as a memory controller and configurable for use with memory.

5. The apparatus as recited in claim 4, further comprising memory operatively coupled to the memory bus interface.

6. The apparatus as recited in claim 5, wherein the memory bus is configured to selectively route the image related data between the memory and at least one of the plurality of logic modules via the bus interface associated with the at least one logic module and the memory bus interface.

7. The apparatus as recited in claim 3, wherein the support bus is configured to selectively route the image related data between at least two of the plurality of logic modules via the two bus interfaces associated with the at least two logic modules.

8. The apparatus as recited in claim 1, wherein at least a portion of the plurality of logic modules are configured to share information with other logic modules through the communication logic.

9. The apparatus as recited in claim 8, wherein the portion of the plurality of logic modules are configured to share information with other logic modules by sending and receiving one or more messages via the communication logic.

10. The apparatus as recited in claim 9, wherein the message includes at least one identifier selected from a group of identifiers comprising a destination identifier, a source identifier, and a bus identifier.

11. The apparatus as recited in claim 9, wherein the message includes a data field capable of carrying the image related data.

12. The apparatus as recited in claim 11, wherein the image related data carried in the data field of the message includes at least one form of data selected from a group of data comprising image data, index data, and address data.

13. The apparatus as recited in claim 1, wherein at least one of the plurality of logic modules is configured to selectively process at least a portion of the image related data according to an image processing algorithm selected from a group of image processing algorithms comprising a half-toning algorithm, a filtering algorithm, a convolution algorithm, an integrating algorithm, a template matching algorithm, a thresholding process algorithm, a matrix operating algorithm, a decoder algorithm, a decompression algorithm, a coder algorithm, and a compression algorithm.

14. The apparatus as recited in claim 1, wherein the data processing order is associated with an image processing pipeline.

15. The apparatus as recited in claim 2, wherein the data processing order is established via control inputs to the plurality of bus interfaces.

16. An apparatus comprising:
a plurality of logic modules, each logic module being configured to selectively process image related data according to a different image processing algorithm;
a plurality of bus interfaces, each bus interface being operatively coupled to a corresponding logic module; and
a plurality of buses, operatively coupled to the plurality of bus interfaces, and wherein the plurality of bus interfaces are configurable to selectively route image related data through the plurality of buses to the plurality of logic modules for processing in accordance with a programmable data processing order.

17. The apparatus as recited in claim 16, wherein the image related data includes at least one form of data selected from a group of data comprising image data, index data, and address data.

18. The apparatus as recited in claim 16, wherein at least one of the plurality of logic modules is configured to selectively process at least a portion of the image related data according to an image processing algorithm selected from a group of image processing algorithms comprising a half-toning algorithm, a filtering algorithm, a convolution algorithm, an integrating algorithm, a template matching algorithm, a thresholding process algorithm, a matrix operating algorithm, a decoder algorithm, a decompression algorithm, a coder algorithm, and a compression algorithm.

19. The apparatus as recited in claim 17, wherein the programmable data processing order causes an image processing pipeline to be formed using at least a portion of the plurality of logic modules.

20. An image processing device comprising:
a memory bus;
at least one support bus;
memory suitable for storing image related data;
a memory bus interface coupled to the memory bus and the memory and configured to provide access to the memory via the memory bus;
a plurality of logic modules, each logic module being configured to process image related data according to a different image processing algorithm; and
a plurality of bus interfaces, each bus interface being coupled to a corresponding logic module, the support bus and the memory bus, and configurable to selectively route the image related data through the support bus and the memory bus to the plurality of logic modules for processing in accordance with a data processing order.

21. The image processing device as recited in claim 20, wherein the image related data includes at least one form of data selected from a group of data comprising image data, index data, and address data.

22. The image processing device as recited in claim 20, wherein at least one of the plurality of logic modules is configured to selectively process at least a portion of the image related data according to an image processing algorithm selected from a group of image processing algorithms comprising a half-toning algorithm, a filtering algorithm, a convolution algorithm, an integrating algorithm, a template matching algorithm, a thresholding process algorithm, a matrix operating algorithm, a decoder algorithm, a decompression algorithm, a coder algorithm, and a compression algorithm.

23. The apparatus as recited in claim 20, wherein the data processing order causes an image processing pipeline to be formed using at least a portion of the plurality of logic modules.

24. The apparatus as recited in claim 20, wherein the data processing order is established via control inputs to the plurality of bus interfaces.

25. The image processing device as recited in claim 20, wherein the image processing device is selected from a group of image processing devices comprising a color printing device, monochrome printing device, an image scanning device, a facsimile device, an image copying device, an image reproduction device, and image displaying device, an image generating device, an image capturing device a still camera device, and a video camera device.
